(19) United States
(12) Patent Application Publication
(10) Pub. No.: US 2009/0276604 A1
(43) Pub. Date: Nov. 5, 2009

(54) ASSIGNING MEMORY FOR ADDRESS TYPES

(75) Inventors: Brian Baird, San Ramon (CA); Shailesh Maskai, Milpitas, CA (US); Puneet Agarwal, Cupertino, CA (US)

Correspondence Address: BRAKE HUGHES BELLERMANN LLP;c/o CPA Global, P.O. Box 52050, Minneapolis, MN, 55402, US

(73) Assignee: Broadcom Corporation, Irvine, CA (US)

(21) Appl. No.: 12/199,409

(22) Filed: Aug. 27, 2008

Related U.S. Application Data
(60) Provisional application No. 61/049,652, filed on May 1, 2008.

(51) Int. Cl. G06F 12/10; G06F 12/16; G06F 12/00

(52) U.S. Cl. 711/206; 711/162; 711/108; 711/E12.001; 711/E12.103

(57) ABSTRACT

Various example implementations are disclosed. According to one example, an integrated circuit may include a key extractor, a translation table block, and a memory assigner. The key extractor may be configured to receive data, extract key-related information from the data, and send the key-related information to a first memory device. The translation table block may be configured to update a mapping table based on a memory assigner assigning physical portions of the first memory device to each of a plurality of address types, receive an index from the first memory device in response to the key extractor sending the key-related information to the first memory device, and send a data request to a second memory device based on the received index, the data request identifying a physical portion of the second memory device.

### PRIORITY CLAIM

This application claims the benefit of priority based on U.S. Provisional Patent Application No. 61/049,652, filed on May 1, 2008, entitled, “Assigning Memory for Address Types,” the disclosure of which is hereby incorporated by reference.

### TECHNICAL FIELD

This description relates to integrated circuits which access memory.

### BACKGROUND

Integrated circuits (ICs), such as application-specific integrated circuits (ASICs) may receive data, such as data included in packets, and route the data based on associated data which is stored in one or more memory devices.

### SUMMARY

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of an integrated circuit and associated devices according to an example implementation.

FIG. 2 is a block diagram showing associations between physical blocks of a first memory device and physical blocks of a second memory device according to an example implementation.

FIG. 3 is a mapping table showing information for mapping blocks of the first memory device to the physical blocks of the second memory device according to an example implementation.

FIG. 4 is a flowchart showing a process according to an example implementation.

### DETAILED DESCRIPTION

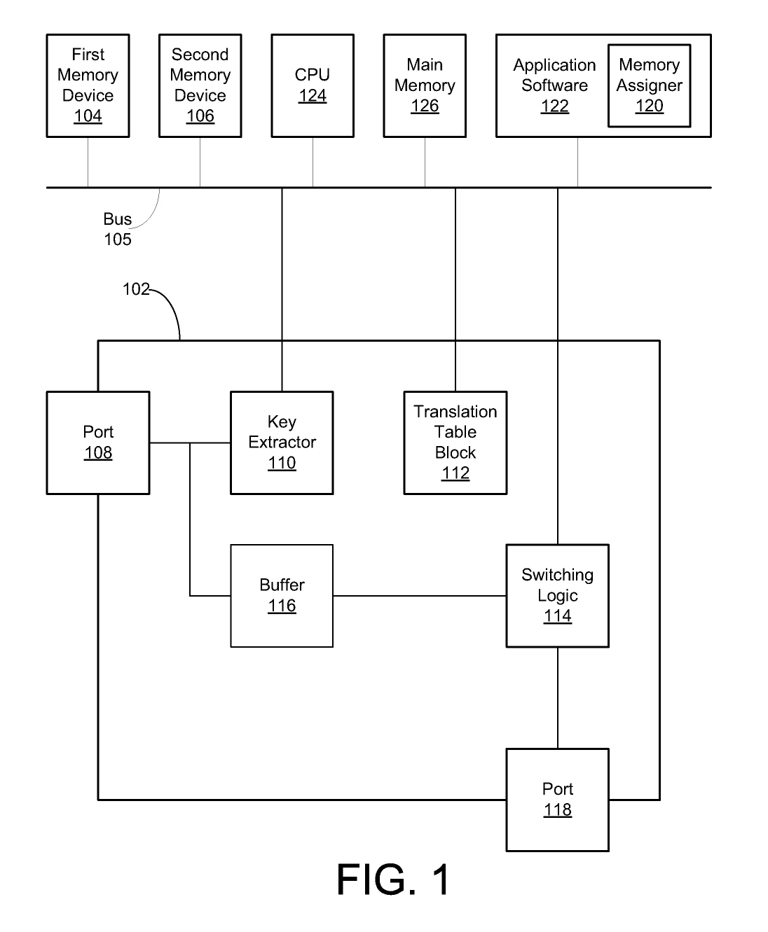

FIG. 1 is a block diagram of an integrated circuit (IC) 102, which may include an application-specific integrated circuit (ASIC) and associated devices according to an example implementation. The IC 102 may receive data, which may be in packet form, extract keys or key-related information from the data, and use the keys to acquire addressing or indexing information which will, in turn, be used to acquire data associated with the received data. In an example implementation, the IC 102 may assign physical blocks of memory to each of a plurality of logical tables. The IC 102 may, for example, dynamically assign the physical blocks based on determined memory needs.

The IC 102 may enter data into the logical tables, such as by downloading the content from application software onto the logical tables. In an example implementation, the logical tables may include lookup tables. The data may be downloaded onto specific physical portions or blocks of memory devices. When a block associated with a logical table becomes full, the IC 102 may assign a new block to the logical table. The blocks may be assigned by application software, according to an example implementation. The application software may keep track of which physical portions or blocks of memory have been assigned to which logical tables, and may assign or reassign the physical portions or blocks according to current needs, according to an example implementation. The blocks may, for example, be assigned to logical tables as the IC 102 is processing data and/or packets.

In an example implementation, the IC 102 may assign physical blocks to logical tables associated with types of addresses, such as level 2 or medium access control (MAC) addresses, level 3 or Internet Protocol (IP) addresses, and/or access control list (ACL) entries. For example, the IC 102 may determine that more memory is needed for level 2 or MAC addresses, and assign a physical block to a logical table associated with level 2 or MAC addresses. The IC 102 may thereafter determine that more memory is needed for level 3 or IP addresses, and assign a physical block to a logical table associated with level 3 or IP addresses. The IC 102 may thereafter determine that the memory allocated for the logical table associated with level 2 or MAC addresses is insufficient, and assign another physical block to the logical table associated with level 2 or MAC addresses. The second physical block assigned to the logical table associated with level 2 or MAC addresses may be noncontiguous with the first physical block assigned to the logical table associated with level 2 or MAC addresses. The IC 102 may thereby assign noncontiguous physical blocks of memory to each of a plurality of logical tables.

The IC 102 may also delete entries, and may determine that a physical portion or block is empty as a result of deletions. The IC 102 may reassign a physical portion or block to a new logical table associated with a different address type.

In the example shown in FIG. 1, the IC 102 may be coupled to a first memory device 104 and to a second memory device 106. The IC 102 may be coupled to the first memory device 104 and/or the second memory device 106 via, for example, a bus 105, such as a generic component interconnect bus. In another example, the first memory device 104 and/or the second memory device 106 may be coupled to the IC 102 via a dedicated bus. The bus 105 and IC 102 may also be coupled to, for example, a central processing unit (CPU) 107, a main memory 109 of the CPU 107, and/or application software 111. The application software 111 may be stored in memory, such as dynamic random access memory (DRAM), according to an example embodiment.

In the example shown in FIG. 1, both the first memory device 104 and the second memory device 106 are external to the IC 102. However, either or both of the first memory device 104 and the second memory device 106 may be included on the IC 102. In an example implementation, the first memory device 104 may include a content addressable memory, such as a ternary content addressable memory (TCAM). Also in an example implementation, the second memory device 106 may include a random access memory, such as a static random access memory (SRAM).

Physical blocks of memory included in the first memory device 104 may be associated with physical blocks of memory included in the second memory device 106. For example, physical blocks of memory included in the first memory device 104 may include indices or addressing information used to find data included in the second memory device 106. For example, the IC 102 may receive data (which may be included in a packet), extract key-related information from the data, and send the key-related information to the first memory device 104. The first memory device 104 may, in response to receiving the key-related information, send an index to the IC 102 based on the key-related information. The index may indicate a physical portion of the second memory device 106, which may store data associated with the received packet. The IC 102, in response to receiving the index, may send the index to the second memory device 106. The IC 102 also may translate the index based on a translation table, and send a translated index or address to the second memory device 106. The second memory device 106 may retrieve the data from a portion of the second memory device's 106 memory based on the received index. The second memory device 106 may send the retrieved data to the IC 102. Based on the data received from the second memory device 106, the IC 102 may forward, route, or drop the received packet, according to an example implementation.

In the example shown in FIG. 1, the IC 102 may receive the data, which may be included in a packet, via a port 108. While one port is shown in FIG. 1 for receiving data, any number of ports 108 may be included in the IC 102. The port 108 may be configured to receive, send, and/or forward packets, according to example implementations. The port 108 may forward the packet to a key extractor 110. The key extractor 110 may extract key-related information from the packet. The key extractor 110 may extract the key-related information from the packet based, for example, on data included in the packet, on a source address included in the packet, and/or on a destination address included in the packet. The key extractor 110 may send the key-related information to the first memory device 104. The key-related information may, for example, indicate a specific logical table associated with an address type and/or physical portions or blocks of the first memory device 104.

The first memory device 104, which may include a TCAM, may include a semiconductor integrated circuit which allows one or more tables of data to be stored in a memory array(s) that incorporates circuitry to permit a search function. The first memory device 104 may search for an index based on the key-related information (which may include a key), such as by performing a table look-up and/or searching the physical blocks associated with the indicated logical table. In an example implementation, the first memory device 104 may search through the physical portions of blocks in a predetermined order, such as ascending order. The search or table look-up may be based on the key or key-related information and/or MAC addresses, IP addresses, or ACL entries. For example, the first memory device 104 may search all physical portions or blocks which are associated with MAC addresses, IP addresses, or ACL entries, depending on the received key or key-related information. The first memory device 104 may, for example, search through the physical portions or blocks from a first end of the first memory device 104 to a second, opposite end of the first memory device 104.

The first memory device 104 may find the index or match index value based on the search using the key or key-related information. The first memory device 104 may provide an indication of whether a match was found or not found based on the search. If a match is found, the first memory device 104 may output the index to the IC 102, such as to a translation table block 112.

The translation table block 112 may store mapping tables which allow logical tables of address types to be specified based on application needs, rather than selecting from a set of predetermined configurations, and may allow noncontiguous physical blocks in the first memory device 104 and/or second memory device 106 to be allocated to the same logical table and/or address type. The translation table block may also allow physical blocks in the first memory device 104 and/or second memory device 106 to be allocated and/or deallocated during run-time, or while application software 122 is running, according to an example embodiment.

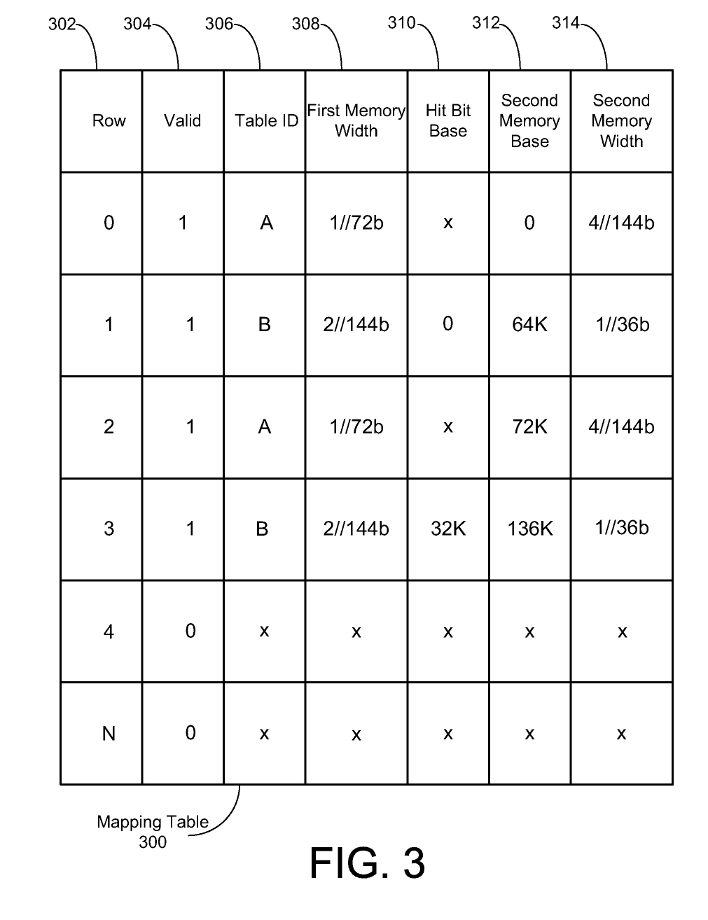

The translation table block 112 may translate the index received from the first external memory device 104 to an address on the second memory device 106. In an example implementation, the translation table block 112 may store a mapping table (described further with reference to FIG. 3) which stores the information needed to map physical blocks to logical tables. In another example implementation, the mapping table may be stored elsewhere on the IC 102.

In an example implementation, the mapping table stored in translation table block 112 is updated when the memory assigner 120 assigns physical portions of the first memory device 104 and/or second memory device 106 to logical tables. The mapping table stored in translation table block 112 may include information indicating associations between logical tables, physical portions or blocks of the first memory device 104, and/or physical portions or blocks of the second memory device 106.

In an example implementation, the translation table block 112 may send a data request to the second memory device 106 based on the received index, such as by checking the received index against the translation table and/or mapping table. The data request may identify a physical portion or block of the second memory device 106, such as by including an address which identifies the physical portion or block of the second memory device 106.

The second memory device 106 may retrieve the data in response to receiving the data request, such as by retrieving the data based on the included address or the identified physical portion or block of the second memory device 106. The second memory device 106 may include rules that determine what actions may be taken on a received packet, such as rules that indicate to drop a packet, to change a packet, or to perform other actions on the packet. Other actions may include determining which port or ports to send the packet to or through. In an example implementation, the second memory device 106 may send the retrieved data, which may include the rule(s), to the IC 102, such as to a switching module 114.

In an example implementation, the switching module 114 may receive the data from the second memory device 106. The switching module 114 also may receive a copy of the received packet, such as via a buffer 116. The switching module 114 may, for example, forward, reroute, or drop the packet based on the data received from the second memory device 106. The switching module 114 may, for example, forward or reroute the packet the packet via a port 118. The port 118 may be configured to receive, send, and/or forward packets, according to example implementations. While one port is shown in FIG. 1 for receiving, sending, and/or forwarding packets, any number of ports 118 may be included in the IC 102.

Application software 122 may include a memory assigner 120. The memory assigner 120 may, for example, determine memory needs for each of the address types, and assign physical portions or blocks of the first memory device 104 to each of the plurality of address types based on the determined memory needs. The memory assigner 120 may assign memory as described in paragraphs [0009] to [0012] above, according to example implementations.

The memory assigner 120 may specify logical tables of address types based on application needs, rather than selecting from a set of predetermined configurations, and may allocated noncontiguous physical blocks in the first memory device 104 and/or second memory device 106 to the same logical table and/or address type. The memory assigner 120 may also allocate and/or deallocate physical blocks in the first memory device 104 and/or second memory device 106 during run-time, or while application software 122 is running. The memory assigner 120 may specify the sizes and/or locations in the first memory device 104 and/or second memory device 106 of logical tables associated with address types both during initialization of the integrated circuit 102 and during run-time, according to an example implementation.

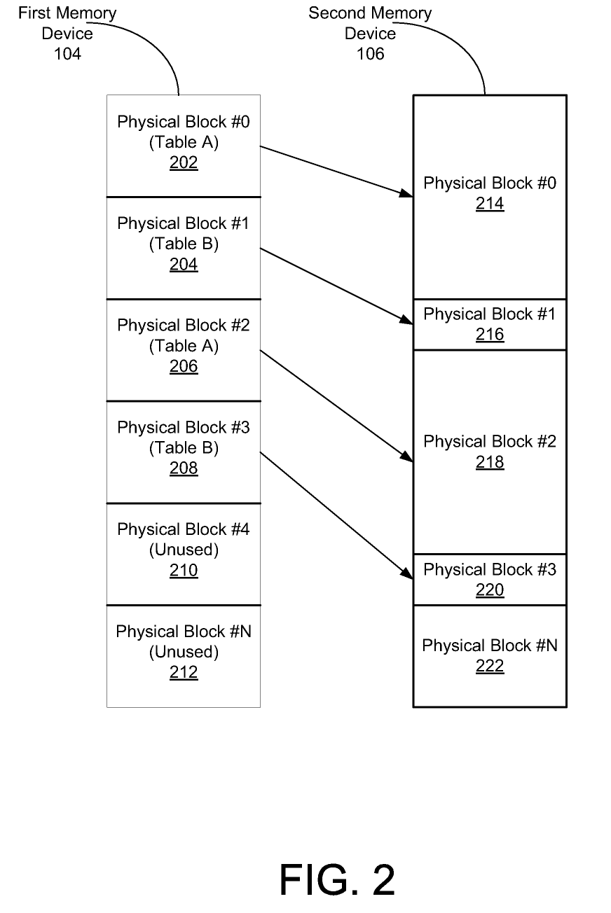

FIG. 2 is a block diagram showing associations between physical blocks of the first memory device 104 and physical blocks of the second memory device 106 according to an example implementation. In an example implementation, each assigned physical block 202, 204, 206, 208 included in the first memory device 104 may be associated with a physical block 214, 216, 218, 220 included in the second memory device 106. The unused physical blocks 210, 212, 222 may be assigned by the application software 122, and/or memory assigner 120 when more memory is needed for a logical table. The memory assigner 120 may, for example, assign a new physical block 202, 204, 206, 208, 210, 212 of the first memory device 104 to a logical table when the logical table needs more memory for more addresses of a certain address type, and may assign a new, associated physical block 214, 216, 218, 220, 222 of the second memory device 106 to the logical table.

The physical blocks 202, 204, 206, 208, 214, 216, 218, 220 assigned to a particular logical table and/or address type need not be contiguous, and may be noncontiguous, according to an example implementation. In the example shown in FIG. 2, physical block #0 202 and physical block #2 206 of the first memory device 104, which are noncontiguous, may be assigned to logical table A, and physical block #0 214 and physical block #2 218 of the second memory device 106, which are also noncontiguous, may also be assigned to logical table A. Similarly, physical block #1 204 and physical block #3 208 of the first memory device 104, which are noncontiguous, may be assigned to logical table B, and physical block #1 216 and physical block #3 220 of the second memory device 106, which are also noncontiguous, may also be assigned to logical table B.

The unassigned physical portions or blocks 210, 212, 222 may be assigned to logical tables by the memory assigner 120 when additional memory is needed, according to an example implementation (additional physical portions or blocks of the first memory device 104 and second memory device 106, not shown, may be unassigned and available for assignment). The physical blocks 202, 204, 206, 208, 210, 212, 214, 216, 218, 220, 222 may be assigned to logical tables associated with address types in any order, and physical blocks 202, 204, 206, 208, 210, 212, 214, 216, 218, 220, 222 assigned to a particular logical table may be contiguous or noncontiguous. In an example implementation, the memory assigner 120 may assign the physical blocks 202, 204, 206, 208, 210, 212, 214, 216, 218, 220, 222 in ascending order, so that the physical blocks 202, 204, 206, 208, 210, 212, 214, 216, 218, 220, 222 which are assigned to any logical table are contiguous beginning at the end of the memory device 104, 106 at which the scanning or searching will begin, according to an example implementation.

In the example shown in FIG. 2, each assigned physical block 202, 204, 206, 208 of the first memory device 104 may be associated with a physical block 214, 216, 218, 220 of the second memory device 106. Each assigned physical block 202, 204, 206, 208 of the first memory device 104 may, for example, include an index which the translation table block 112 may translate or map into an address or physical portion of a corresponding physical block 214, 216, 218, 220 of the second memory device 106.

Physical blocks 202, 204, 206, 208, 210, 212, 214, 216, 218, 220, 222 assigned to logical tables may not all be the same size. In the example shown in FIG. 2, all the assigned physical blocks 202, 204, 206, 208 in the first memory device 104 are the same size, but the physical blocks 214, 218 in the second memory device 106 assigned to table A are four times the size as the physical blocks 216, 220 in the second memory device which are assigned to table B. In other example implementations, all physical blocks 202, 204, 206, 208 in the first memory device 104 which are assigned to any logical table may be the same size. The physical blocks 202, 204, 206, 208 in the first memory device 104 which are assigned to the same logical table may be the same size, or the assigned physical blocks 202, 204, 206, 208 in the first memory device 104 may all have different sizes. Similarly, all physical blocks 214, 216, 218, 220 in the second memory device 106 which are assigned to any logical table may be the same size. The physical blocks 214, 216, 218, 220 in the second memory device 106 which are assigned to the logical table may be the same size, or the assigned blocks 214, 216, 218, 220 in the second memory device 106 may all have different sizes. The memory assigner 120 may, for example, assign a physical portion of the first memory device 104 and/or second memory device 106 based on determined memory needs for each address type.

FIG. 3 is a mapping table 300 showing information for mapping physical blocks 202, 204, 206, 208 of the first memory device 104 to the physical blocks 214, 216, 218, 220 of the second memory device 106, according to an example implementation. The mapping table 300 may be stored in the translation table block 112, the IC 102, the memory assigner 120, and/or application software, for example. The mapping table 300 may be generated based on memory assignments made by the memory assigner 120, according to an example implementation.

In the example shown in FIG. 3, the mapping table 300 may include a “row” column 302. The row column 302 may include a unique row number for each row in the mapping table 300. The row number may, for example, correspond to or identify a physical block number of the first memory device 104. The mapping table 300 also may include a “valid” column 304. The value of the valid column 304 may indicate whether the physical block 202, 204, 206, 208, 210, 212 of the first memory device 104 identified by the corresponding row number has been assigned to a logical table and/or an address type. In the example shown in FIG. 3, a ‘1’ indicates that the physical block physical block 202, 204, 206, 208, 210, 212 has been assigned, and a ‘0’ indicates that the physical block 202, 204, 206, 208, 210, 212 has not been assigned. This is merely an example. Other notations for indicating whether a physical block 202, 204, 206, 208, 210, 212 has been assigned may be used. In an example implementation, the value of the row column 302 may be used to assign physical blocks 202, 204, 206, 208, 210, 212. For example, the IC 102 or memory assigner 120 may assign the next unassigned physical block 202, 204, 206, 208, 210, 212 to a logical table and/or address type which needs more memory.

In the example shown in FIG. 3, the mapping table 300 also may include a “table ID” column 306. The entries in the table ID column 306 may identify the logical table associated with the entries in the row. In the example shown in FIG. 3, the table ID column 306 may indicate whether the entries in a given row are associated with table A (which may be associated with a first address type), with table B (which may be associated with a second address type), or are not associated with any table (indicated by an ‘x’). In other example implementations, the rows may be associated with any number of logical tables and/or address types, rather than only two as in the example shown in FIG. 3.

The mapping table 300 also may include entries for finding physical blocks 202, 204, 206, 208, 210, 212, 214, 216, 218, 220, 222 on the first and second memory devices 104, 106, and/or for mapping a physical block 202, 204, 206, 208, 210, 212 of the first memory device 104 onto a physical block 214, 216, 218, 220, 222 of the second memory device 106. For example, the mapping table 300 may include a “first memory width” column 308 indicating a width or size of each physical block 202, 204, 206, 208, 210, 212 of the first memory device 104. In the example shown in FIG. 3, the entries in the first memory width column 308 may indicate the size of each physical block 202, 204, 206, 208, 210, 212 of the first memory device 104. The IC 102 and/or translation table block 112 may use the entries in the first memory width column 308 to determine the location of a physical block 202, 204, 206, 208, 210, 212 of the first memory device 104, such as by adding the values of all preceding physical blocks 202, 204, 206, 208, 210, 212.

The mapping table 300 also may include a “hit bit base” column 310. The entries in the hit base column 310 may indicate locations of hit bits in the second memory device 106, or in another memory device, according to example implementations. In some implementations, some but not all of the logical tables associated with address types mapped by the mapping table 300 may be associated with hit bits. In the example shown in FIG. 3, the ‘x’s in the table A rows indicate that logical table A is not associated with hit bits. For the table B rows, which are associated with hit bits, the entries in the hit bit base column 310 indicate where the hit bits begin. For example, in row 1, the hit bits begin at zero, whereas in row three, the hit bits begin at 32K. The memory device which stores the hit bits may use the hit bit column 310 to find the hit bits associated with a physical portion or block of the first memory device 104 or second memory device 106.

The mapping table 300 also may include a “second memory base” column 312. The entries in the second memory base column 312 may indicate starting points of physical portions or blocks of the second memory device 106 which correspond to physical portions or blocks of the first memory device 104. In the example shown in FIG. 3, the physical blocks of the second memory device 106 assigned to table A each have a length of 64K, causing the starting point of the next block to be 64K higher than the physical block assigned to table A, whereas the physical blocks of the second memory device 106 assigned to table B each have a length of 8K, causing the starting point of the next block to be 8K higher than the physical block assigned to table B. The entries in the second memory base column 312 may be used by the IC 102, translation table block 112, and/or second memory device 106 to find and/or address a physical portion or block of the second memory device 106 associated with a physical portion or block of the first memory device 104.

The mapping table 300 may include a second memory width column 314 indicating a width or size of each physical block 214, 216, 218, 220, 222 of the second memory device 106. In the example shown in FIG. 3, the entries in the second memory width column 314 may indicate the size of each physical block 214, 216, 218, 220, 222 of the second memory device 106. The IC 102 and/or translation table block 112 may use the entries in the second memory width column 314 to determine the location of a physical block 214, 216, 218, 220, 222 of the second memory device 106, such as by adding the values of all preceding physical blocks 214, 216, 218, 220, 222.

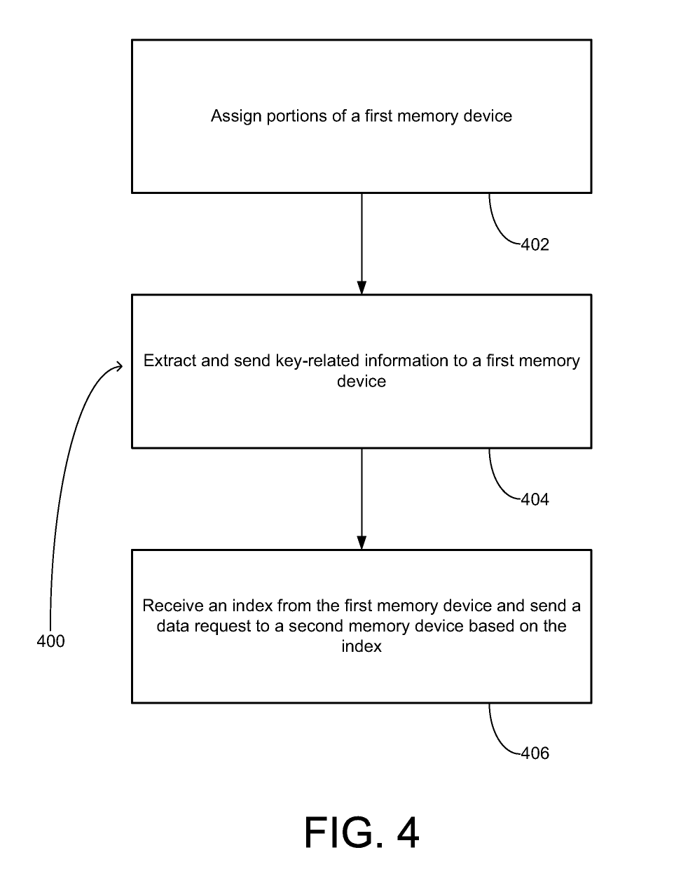

FIG. 4 is a flowchart showing a process 400 according to an example implementation. In this example, the process 400 may include assigning physical portions of a first memory device 104 (402). The physical portions may be assigned, for example, by the memory assigner 120 based on determined memory needs for address types. The process 400 also may include extracting and sending key-related information to a first memory device 104 (404), such as by a key extractor 110. The process 400 may also include receiving an index from the first memory device 104 and sending a data request to a second memory device 106 based on the index (406), such as by a translation table block 112.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the implementations of the invention.

What is claimed is:

1. An integrated circuit comprising:
a key extractor configured to receive data, extract key-related information from the data based in part on an address included in the data, and send the key-related information to a first memory device;
a translation table block configured to:
update a mapping table based on a memory assigner assigning physical portions of the first memory device to each of a plurality of address types;
receive an index from the first memory device in response to the key extractor sending the key-related information to the first memory device; and
send a data request to a second memory device based on the received index and the mapping table, the data request identifying a physical portion of the second memory device.

2. The integrated circuit of claim 1, wherein the integrated circuit is coupled to a memory assigner configured to:
determine memory needs for each of the plurality of address types; and
assign physical portions of the first memory device to each of the plurality of address types based on the determined memory needs.

3. The integrated circuit of claim 1, wherein the key extractor is configured to receive the data, extract the key-related information from the data, and send the key-related information to the first memory device, the key-related information indicating one of the plurality of address types.

4. The integrated circuit of claim 1, wherein the key extractor is configured to receive the data, the data being included in a packet, extract key-related information from the packet, and send the key-related information to the first memory device.

5. The integrated circuit of claim 1, wherein the translation table block is configured to update the mapping table based on the memory assigner determining that a physical portion of the first memory is empty and reassigning the physical portion to a different address type.

6. The integrated circuit of claim 1, wherein the translation table block is configured to update the mapping table based on memory assigner assigning the physical portions of the first memory device to each of the plurality of address types, with at least two of the physical portions assigned to each address type being noncontiguous.

7. The integrated circuit of claim 1, further comprising a switching module configured to receive a copy of the data received by the key extractor and route the data based on data received from the second memory device.

8. The integrated circuit of claim 1, wherein:
the key extractor is configured to receive the data, extract the key-related information from the data, and send the key-related information to the first memory device, the first memory device including a ternary content addressable memory (TCAM); and
the translation table block is configured to receive the index from the TCAM and send the data request to the second memory device based on the received index.

9. The integrated circuit of claim 1, wherein the a translation table block is configured to:
update the mapping table based on the memory assigner assigning physical portions of the first memory device to each of a plurality of address types, the assigned physical portions being of different sizes for each address type;
receive an index from the first memory device in response to the key extractor sending the key-related information to the first memory device; and
send the data request to the second memory device based on the received index and the mapping table, the data request identifying the physical portion of the second memory device.

10. A computer program product for assigning memory, the computer program product being tangibly embodied on a computer-readable medium and including executable code that, when executed, is configured to:
determine memory needs for each of a plurality of address types;
assign a plurality of physical portions of a ternary content addressable memory (TCAM) to each of a plurality of logical tables associated with the plurality of address types based on the determined memory needs; and
instruct an integrated circuit to update a translation table based on the assigned physical portions of the TCAM, the translation table storing associations between the physical portions of the TCAM and physical portions of a static random access memory (SRAM).

11. The computer program of claim 10 that is further configured to empty and reassign at least one of the plurality of physical portions of the TCAM based on the determined memory needs.

12. An integrated circuit comprising:
a port configured to receive a packet, the packet including an address;
a key extractor configured to receive the packet, extract a key from the packet based on the addrerss, and send the key to a first memory device;
a translation table block configured to:
store a mapping table, wherein the mapping table maps physical blocks in the first memory device to physical blocks in a second memory device;
receive an index from the first memory device, the index being based on the key;
translate the index into a memory address based on the mapping table, the memory address identifying a location on the second memory device; and
send a data request to the second memory device, the data request including the memory address which identifies the physical block of the second memory device; and
a switching module configured to receive data from the second memory device and process the packet based on the data received from the second memory device.

13. The integrated circuit of claim 12, wherein:
the key extractor is configured to receive the packet, extract the key from the packet, and send the key to the first memory device, the first memory device including a Ternary Content Addressable Memory (TCAM); and
the translation table block is configured to:
store the mapping table, wherein the mapping table maps physical blocks in the TCAM to physical blocks in the second memory device;
receive the index from the TCAM;
translate the index into the memory address based on the mapping table; and
send the memory address to the second memory device.

14. The integrated circuit of claim 12, wherein:
the translation table block is configured to:
store the mapping table which maps physical blocks in the first memory device to physical blocks in the second memory device;
receive the index from the first memory device, the index being based on the key;
translate the index into the memory address based on the mapping table, the memory address identifying a location on the second memory device, the second memory device including a static random access memory (SRAM) module; and
send the data request to the SRAM module; and
the switching module is configured to receive the data from the SRAM module and process the packet based on the data received from the second memory device.

15. The integrated circuit of claim 12, wherein the translation table block is further configured to update the mapping table by mapping unassigned physical blocks of the first memory device to unassigned physical blocks of the second memory device.

16. The integrated circuit of claim 12, wherein the translation table block is further configured to update the mapping table by mapping an updated physical block of the first memory device to an updated physical block of the second memory device and associate the mapped physical blocks of the first memory device with an updated set of Medium Access Control (MAC) addresses, the updated physical block of the first memory device being noncontiguous with at least one physical block of the first memory device previously associated with a previous set of MAC addresses.

17. The integrated circuit of claim 12, wherein the translation table block is further configured to update the mapping table by mapping an updated physical block of the first memory device to an updated physical block of the second memory device and associate the mapped physical blocks of the first memory device with an updated set of Internet Protocol (IP) addresses, the updated physical block of the first memory device being noncontiguous with at least one physical block of the first memory device previously associated with a previous set of IP addresses.

18. The integrated circuit of claim 12, wherein the translation table block is further configured to update the mapping table by mapping an updated physical block of the first memory device to an updated physical block of the second memory device and associate the mapped physical blocks of the first memory device with an updated set of access control list (ACL) entries, the updated physical block of the first memory device being noncontiguous with at least one physical block of the first memory device previously associated with a previous set of ACL entries.

19. The integrated circuit of claim 12, wherein the translation table block is further configured to update the mapping table by associating physical blocks in the first memory device with Internet Protocol (IP) addresses, wherein the physical blocks in the first memory device were previously associated with Medium Access Control (MAC) addresses.

20. The integrated circuit of claim 12, wherein the translation table block is further configured to update the mapping table by associating physical blocks in the first memory device with Medium Access Control (MAC) addresses, wherein the physical blocks in the first memory device were previously associated with Internet Protocol (IP) addresses.
